(19) United States
(12) Patent Application Publication
(10) Pub. No.: US 2015/0199125 A1
(43) Pub. Date: Jul. 16, 2015

(54) DISPLAYING AN APPLICATION IMAGE ON TWO OR MORE DISPLAYS

(71) Applicant: LENOVO (Singapore) PTE, LTD., New Tech Park (SG)

(72) Inventors: Yasumichi Tsukamoto, Yamato-shi (JP); Yuichi Shigematsu, Sagamihara-shi (JP)

(21) Appl. No.: 14/595,995

(22) Filed: Jan. 13, 2015

(30) Foreign Application Priority Data
Jan. 14, 2014 (JP) 2014-003844

(51) Int. Cl. G06F 3/0488; G06F 3/0481

(52) U.S. Cl. CPC G06F 3/04883; G06F 3/04817

(57) ABSTRACT

An application image is displayed effectively on touch-operable displays. Multiple launch icons including launch icons are displayed on touch screens. When a flick operation in a left direction is performed on the launch icon, an image is displayed on the touch screen, while when a flick operation in a right direction is performed, the image is displayed on the touch screen. When a flick operation in the right direction is performed from a launch icon after a flick operation is performed on the touch screen to display the launch icon while the image is displayed on the touch screen, a second image may be displayed on the touch screen.

The present invention relates to a technique for making effective use of each display in a system for displaying an application image on two or more displays including a touch-operable display, and further to a technique for displaying an application image on an intended display with an intuitive touch operation.

### BACKGROUND

In an electronic device such as a laptop personal computer (laptop PC), a tablet computer (tablet PC), a mobile phone, or a multifunctional mobile phone (smartphone), an image may be displayed on two or more displays including a touch-operable display (hereinafter called a touch screen). The touch screen is made up of a flat panel display (FPD) and a touch panel capable of recognizing a touch operation on the FPD.

In one form of usage of two or more displays in such an electronic device, two chassis, each equipped with a touch screen, are coupled foldably by a hinge mechanism. Such an electronic device is called a foldable electronic device below. In another form of usage, an external monitor such as any other display or a projector is connected to the electronic device to display image data output from the electronic device. A program operable by a user using the touch screen can be shifted to an execution state with a touch operation on a launch icon with which the program is associated.

### SUMMARY

FIG. 11 is a plan view of a foldable smartphone. A smartphone 800 is configured such that chassis 801a and 801b are coupled by hinge mechanisms 805a and 805b to be openable and closable. Each of the chassis 801a and 801b is equipped with each of touch screens 803a and 803b, respectively. In one form of usage of the touch screens 803a and 803b, the touch screen 803a is positioned as a main screen and the touch screen 803b is positioned as an auxiliary screen.

On the touch screen 803a, multiple launch icons 807 for application programs (applications) installed by a user are mainly displayed. The system holds image data in a manner to display a number of launch icons, which go beyond a display area of the touch screen 803a, in a virtual display area set in an extended partition of the touch screen 803a. Launch icons hidden from the display area can be moved to the display area with a swipe operation on the touch screen 803a. On the touch screen 803b, only launch icons 809 for predefined applications, such as a web browser, a mailer, photograph display, and music playback.

Then, an application image when a launch icon 807 is touched is displayed on the touch screen 803a, and an application image when a launch icon 809 is touched is displayed on the touch screen 803b. The application images once displayed cannot be moved from one touch screen to the other touch screen. In FIG. 11, a launch icon 809a for the web browser and a launch icon 809b for the mailer are exemplified.

As a problem arising here, for example, there is a need that when a mail is to be sent with a touch operation on the launch icon 809a while displaying an image of the web browser on the touch screen 803b, the launch icon 809b for the mailer is touched to display an image of the mailer on the touch screen 803b after returning to the home screen once or closing the web browser. After that, there is a need to touch the launch icon 809a for the web browser again after closing the image of the mailer in order to return to the web browser, making the operations complicated.

In this case, even when no application image useful for the user is displayed on the touch screen 803a, the image of the mailer cannot be displayed on the touch screen 803a while leaving the image of the web browser on the touch screen 803b. The same thing occurs between two launch icons displayed on the touch screen 803a. In the method of Patent Document 1, a special pair icon is so created that the pair icon can be displayed on two screens at the same time, but it takes time and effort to create the pair icon. Further, since the arrangement of the pair icon and the screens on which applications are displayed are associated with each other in advance, an application image cannot be displayed at a position contrary to the above on a screen favorable to the user according to the working state at the time after the pair icon is created.

The present embodiments are applied to an electronic device equipped with two or more displays. A first display is touch-operable, and a second display may be touch-operable or not. In a first aspect, a launch icon is first displayed on the first display. Then, the type of touch operation on the launch icon is identified. Then, an application image associated with the launch icon is displayed on the first display and the second display, or on either one of the displays according to the identified type of touch operation.

According to this configuration, a user can select a touch operation to run an application and display an application image on an intended display. Although the touch operation may be a tap operation, if a gesture operation from the launch icon as a start point is performed, it is possible to perform an intuitive operation in association with the relative arrangement of the displays. If the gesture operation is a flick operation, an application image can be displayed in a short operation time.

When a gesture operation in a direction of the first display relative to the second display is detected, the application image is displayed on the first display, while when a gesture operation in a direction of the second display relative to the first display is detected, the application image is displayed on the second display. In this case, since the position of the display to be displayed can be made to match with the direction of the gesture operation, an intuitive operation can be performed.

If the application image is displayed on the first display after an application image already displayed on the first display is displayed on the second display when a gesture operation in a predetermined direction is detected, the application image displayed on the first display up to that time can be subsequently displayed on the second display.

When a gesture operation in a predetermined direction is detected, an application image using the first display and the second display as one screen may be displayed on the first display and the second display. When a gesture operation in a predetermined direction is detected, a property window for an application program associated with a launch icon may also be displayed. Further, when a gesture operation in a predetermined direction is detected, an application image may be displayed on an external monitor connected to the electronic device. Further, when a gesture operation in a predetermined direction is detected, an application program associated with a launch icon may be deleted.

When a touch operation on the second display is enabled, any application image may be displayed on the first display in a manner to be overlaid on a launch icon before a touch operation is performed on the launch icon. In this state, the touch operation on the launch icon cannot be performed. However, if the launch icon is displayed on the second display in response to a gesture operation on the second display while maintaining the display of the first display, and an application image associated with the launch icon is displayed on the second display according to the type of touch operation on the launch icon displayed on the second display, it will no longer be necessary once to close the application image displayed on the first display.

In a second aspect of the present embodiments, a launch icon is first displayed on a touch-operable display. Then, multiple auxiliary images, each indicating information that implies the next operation, are displayed around the launch icon in response to a gesture operation from the launch icon as a start point. Then, the gesture operation is identified. Then, processing corresponding to the identified gesture including processing for displaying an application image associated with the launch icon on either one of the displays or on the two or more displays is performed.

The display of the auxiliary images can lead to accurate identification even if the types of gesture operations for the launch icon increase, and make it easier for even an unaccustomed user to perform operations. The implicit information can include information on a display on which an application image is to be displayed, information for displaying a property window for an application program associated with the application image, information for displaying the application image on an external monitor, and information for deleting the application image.

The configuration can be such that a drag operation headed for any one of the auxiliary images is identified, an auxiliary image located at an end point of the drag operation is recognized, and processing associated with information implied by the auxiliary image is performed. The processing associated with information implied by the auxiliary image can be either to display a property window for an application program associated with the launch icon or to delete the application program.

Multiple sub-auxiliary images, each indicating information that implies the next operation, can be displayed around an auxiliary image in response to the fact that the auxiliary image is recognized. The information implied by a sub-auxiliary image includes information that implies the position of a display for displaying a property window for an application program associated with the application image, and in response to the fact that a gesture operation headed for the sub-auxiliary image is identified, the property window can be displayed on either one of the displays.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 is a plan view of a smartphone 100 according to one embodiment;

FIG. 2A is a diagram showing a state of displaying launch icons on the smartphone 100;

FIG. 2B is a diagram showing a state of displaying launch icons on the smartphone 100;

FIG. 2C is a diagram showing a state of displaying launch icons on the smartphone 100;

FIG. 2D is a diagram showing a state of displaying launch icons on the smartphone 100;

FIG. 3A is a diagram for describing an example of an application running method according to one embodiment;

FIG. 3B is a diagram showing an example of an application running method according to one embodiment;

FIG. 3C is a diagram showing an example of an application running method according to one embodiment;

FIG. 3D is a diagram showing an example of an application running method according to one embodiment;

FIG. 4A is a diagram showing an example of an application running method using guide images 250 and 270;

FIG. 4B is a diagram showing an example of an application running method using guide images 250 and 270;

FIG. 5 is a functional block diagram showing an example of the hardware configuration of the smartphone 100;

FIG. 6 is a functional block diagram for describing the configuration of a display system 500 for processing an operation for a launch icon;

FIG. 7 is a flowchart for describing an example of the operation of the display system 500;

FIG. 8 is a flowchart for describing the example of the operation of the display system 500;

FIG. 9A is a diagram showing a screen state of touch screens 200 and 300 that vary according to the procedure in FIG. 7 or FIG. 8;

FIG. 9B is a diagram showing a screen state of touch screens 200 and 300 that vary according to the procedure in FIG. 7 or FIG. 8;

FIG. 9C is a diagram showing a screen state of touch screens 200 and 300 that vary according to the procedure in FIG. 7 or FIG. 8;

FIG. 10D is a diagram showing a screen state of the touch screens 200 and 300 that vary according to the procedure in FIG. 7 or FIG. 8;

FIG. 10E is a diagram showing a screen state of the touch screens 200 and 300 that vary according to the procedure in FIG. 7 or FIG. 8;

FIG. 11 is a plan view for describing a conventional method of displaying an application image on a foldable smartphone.

### DETAILED DESCRIPTION

In this specification, terms in relation to a series of coherent input operations on a touch screen are used in the following sense from the standpoint of the presence or absence of a change in the coordinates detected by the system, the rate of change when the coordinates change, and the amount of time during which input is being given to the same coordinates when the coordinates do not change. The touch operations mean all input operations for enabling the system to recognize the input coordinates regardless of whether a finger or an electronic pen (hereinafter simply called a finger collectively including both in the specification) touches the surface of a touch screen.

The touch operations include both an input operation on an icon associated with a specific application or a specific file to be displayed on a touch screen (hereinafter called a launch icon) or an object such as a character or an image associated with a predetermined location (hereinafter called a specific object), and an input operation on a display area other than the specific object.

The touch operations include a tap operation in which the position of the touch operation does not change during a series of coherent operations, and a gesture operation in which the position changes. The system that has detected a tap operation can obtain information, such as the coordinates at which the touch operation was carried out, the duration of the touch operation on the coordinates, and the number of times the touch operation was carried out. The tap operations include a short tap operation for conducting a touch operation of less than a predetermined time and a long tap operation for conducting a touch operation of more than or equal to the predetermined time. The tap operations include a single-tap operation for conducting the short tap operation once, and a double-tap operation for conducting the short tap operation twice.

The gesture operations include single touch operations such as a flick operation, a swipe operation, a drag operation, and a turning operation, and multitouch operations such as pinch-in and pinch-out. The system that has detected a gesture operation can obtain information such as the trajectory of the coordinates at which the touch operation was carried out and the speed at which the coordinates changes. Then, the system can identify the type of gesture from a trajectory pattern of the coordinates, the direction of the change, and the like.

The flick operation means an operation for moving a finger performing the touch operation over a short distance in a roughly fixed direction. The swipe operation means an operation for moving the finger performing the touch operation over a distance longer than the flick operation in the roughly fixed direction, which is also called a slide operation. The flick operation means an operation in which the moving speed of the finger is higher than the swipe operation. The drag operation means an operation for moving the finger touching a specific object to a predetermined position. At this time, the specific object on which the touch operation was carried out may be or may not be moved along with the finger. Further, the predetermined position as a destination may be in an area where the specific object is displayed or in any display area of the touch screen other than that area.

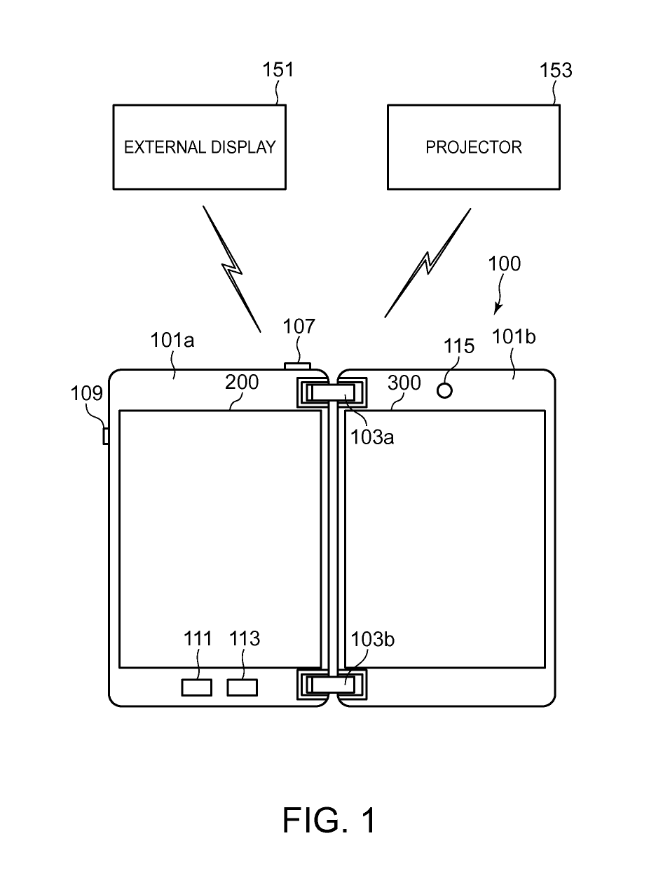

FIG. 1 is a plan view of a smartphone 100 as an example of an electronic device equipped with two touch screens. In the application of the present invention, the configuration can also be such that one is a touch screen and the other is a display that enables only a display. The number of displays or touch screens equipped in the electronic device is not particularly limited as long as at least one of them is a touch screen.

As another example of the electronic device capable of applying the present invention, a laptop PC, a mobile phone, a tablet PC, and the like can be cited. The present invention can further be applied to a method of displaying an application image between an electronic device equipped with a single touch screen and an external monitor. Here, a foldable smartphone 100 is exemplified, but there is no need to limit the present invention thereto. The present invention can be applied to a system or an electronic device capable of providing two or more displays including a display that enables at least one touch operation.

In FIG. 1, the smartphone 100 is so configured that chassis 101a and 101b are coupled by hinge mechanisms 103a and 103b to be openable and closable. The chassis 101a and 101b are so configured that respective display areas are equipped with rectangular touch screens 200 and 300. The smartphone 100 is used in a state of being opened laterally relative to a user in FIG. 1, but it can also be used by rotating 90 degrees to the right or left relative to the user to open up and down. In this case, the orientation of images displayed on the touch screens 200 and 300 may be rotated according to the change in the attitude of chassis.

Each of the touch screens 200 and 300 is made up of an FPD and a touch panel. The touch panel can detect the coordinates of a finger that performed a touch operation on the FPD. In applying the present invention, there is no need particularly to limit the structure of the FPD, and a liquid crystal panel, a plasma display panel, an organic EL panel, or the like can be adopted. There is also no need to limit the detection principle of the touch panel, and a capacitive type, a resistive film type, an inductive type, an ultrasonic surface acoustic wave type, an infrared operating type, or the like can be adopted. For the touch panel, both a single touch system for detecting the coordinates of one finger alone and a multi-touch system for detecting the coordinates of two or more fingers at the same time can be adopted.

The smartphone 100 can display an application image on an external monitor such as an external display 151 or a projector 153 by establishing a connection to the external monitor through a cable or by radio. The smartphone 100 includes hardware buttons, such as a power button 107 for operating a power supply, a volume control button 109 for changing the volume level, a home button 111 for returning to a home screen, and a backspace button 113 for returning to the previous state. Note that the function of each button except the power button 107 can also be realized by a touch operation on the touch screens 200 and 300. The smartphone 100 further includes a camera 115, a speaker and a microphone, not shown, and the like.

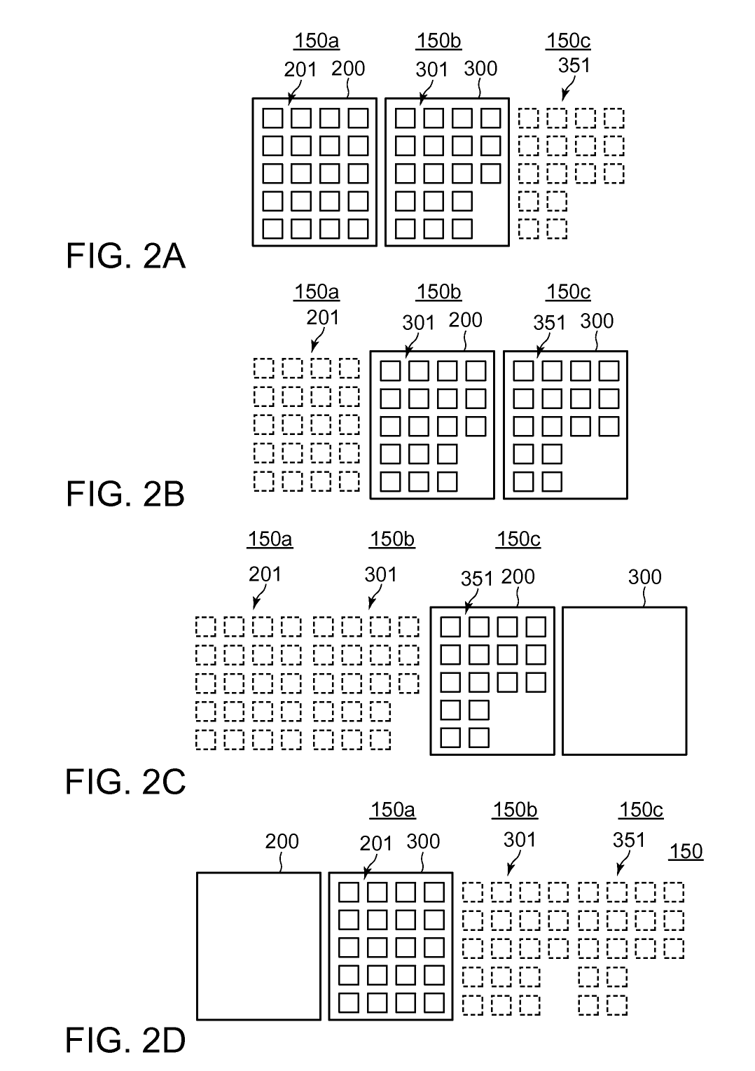

FIG. 2 is a diagram for describing a state in which the smartphone 100 displays launch icons. Each launch icon is associated with a specific application, a specific file, or the like, meaning an object displayed on a touch screen to run the application or run an application associated with the file in order to display the file. Since a file launch icon is accompanied with running of the application when a touch operation is carried out, the file launch icon is included in application launch icons in the specification.

An image to be displayed when an application is started by a touch operation on a launch icon is called an application image. The application image may be displayed in either a full-screen display format using the entire display area of the touch screen 200 or the touch screen 300, or in a window format using an area smaller than the entire display area.

The launch icon becomes a target of a touch operation, and uninstallation, the display of a property window, and the like can be done through launch icons in addition to running an associated application in the embodiment. The launch icons are small image objects, such as graphic figures, photos, symbols, or characters, including information that implies the contents of applications or files associated therewith.

The outlines of the launch icons may be all of the same shape such as a rectangle, or of shapes that illustrate the concepts of concrete things such as a clock and a camera. When an application is installed on the smartphone 100, a launch icon associated with the application is generated. A screen on which the launch icon created when the application is installed is displayed is generally called a home screen. The home screen means a screen to be first displayed when the power button 107 is pressed and held down to turn on the power supply of the smartphone 100. The home screen is also a screen to be displayed when the home button 111 is pressed after the smartphone is started.

The launch icons may be displayed on a screen such as an all application screen different from the home screen. For example, there is a method of displaying launch icons for all installed applications on the all application screen while displaying, on the home screen, always operating application images called widgets, each of which displays the weather forecast, the calendar, or the time, and launch icons for frequently used applications. FIG. 2 shows screens, on which one or more launch icons are displayed, irrespective of the home screen or the all application screen (hereinafter called page screens 150a to 150c).

In FIG. 2, such an orientation that the touch screen 200 is the left side and the touch screen 300 is right side of the smartphone 100 as seen from the user is defined. The number of launch icons to be displayed on the touch screens 200 and 300 at a time is limited to be convenient for touch operations. In FIG. 2, a state of displaying a maximum of 20 launch icons on each of the touch screens 200 and 300 is shown as an example. When applications are installed, launch icons are added in order on the page screens 150a to 150c. Alternatively, the user can select a page screen on which an application is to be installed upon installation.

When the number of page screens 150a to 150c becomes three or more, all the launch icons cannot be displayed on the touch screens 200 and 300 at a time. In this case, the system holds launch icons included in the page screen 150c that is part of the page screens as image data to be displayed on a virtual touch screen. FIG. 2A shows a state in which the system displays a launch icon group 201 on the touch screen 200, displays a launch icon group 301 on the touch screen 300, and further holds image data of a launch icon group 351 on the virtual touch screen.

In order to display the launch icon group 351 on the touch screen 300, a swipe operation or a flick operation to the left side relative to the touch screen 200 or the touch screen 300 is performed to move the page screen 150c in the left direction as shown in FIG. 2B. At this time, the launch icon group 201 moves to the virtual touch screen residing outside of the display area of the touch screen 200, 300. In order to display the launch icon group 351 on the touch screen 200, a swipe operation or a flick operation further to the left side relative to the touch screen 200 or the touch screen 300 is performed to move the page screen 150c in the left direction as shown in FIG. 2C.

At this time, the launch icon groups 201 and 301 move outside of the display area of the touch screen 200, 300 so that any launch icon will not be displayed on the touch screen 300. In order to display the launch icon group 201 on the touch screen 300 in the state of FIG. 2A, a swipe operation or a flick operation to the right side relative to the touch screen 200 or the touch screen 300 is performed to move the page screen 150a in the right direction as shown in FIG. 2D.

At this time, the launch icon groups 301 and 351 move outside of the display area of the touch screen 200, 300 so that any launch icon will not be displayed on the touch screen 200. When the touch screen 300 is a normal display on which no touch operation cannot be performed, since only one page screen can be displayed on the touch screen 200, launch icons included in the other page screens move to the virtual touch screen.

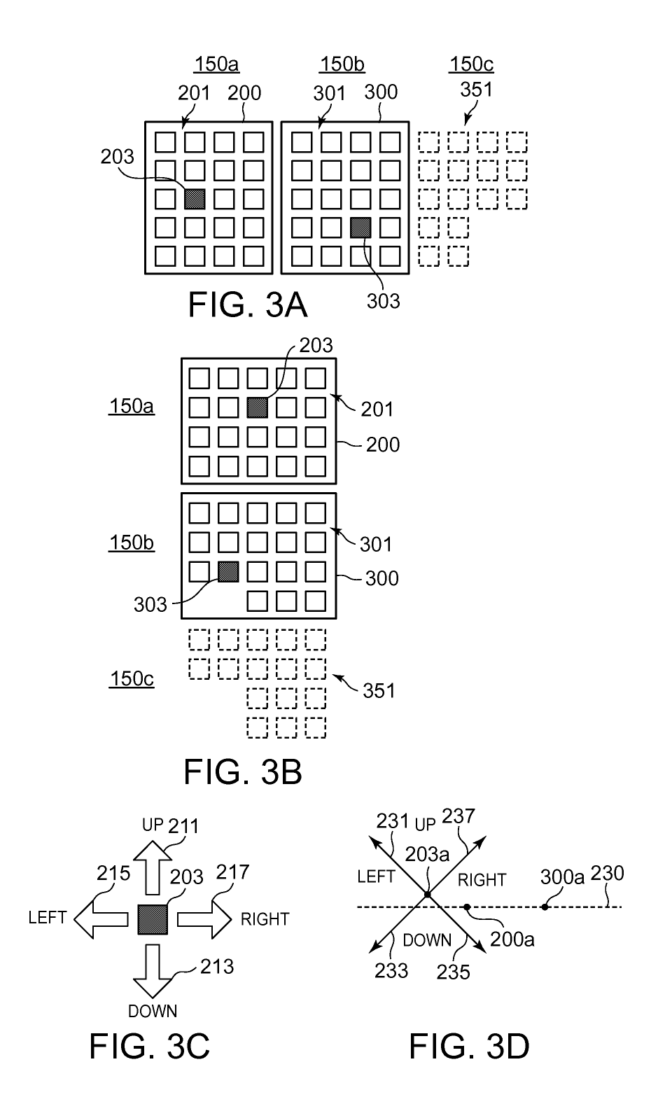

FIG. 3 is a diagram for describing an example of an application running method according to the embodiment. In this example, an application associated with a launch icon 203 shown in FIG. 3A is started with a touch operation so that the application image can be displayed on the touch screen 200 or the touch screen 300 intended by the user. The relative position of the touch screen 200 and the touch screen 300 as seen from the user is so defined that the touch screen 200 is the left side and the touch screen 300 is the right side. At this time, the upside and the downside can be defined together.

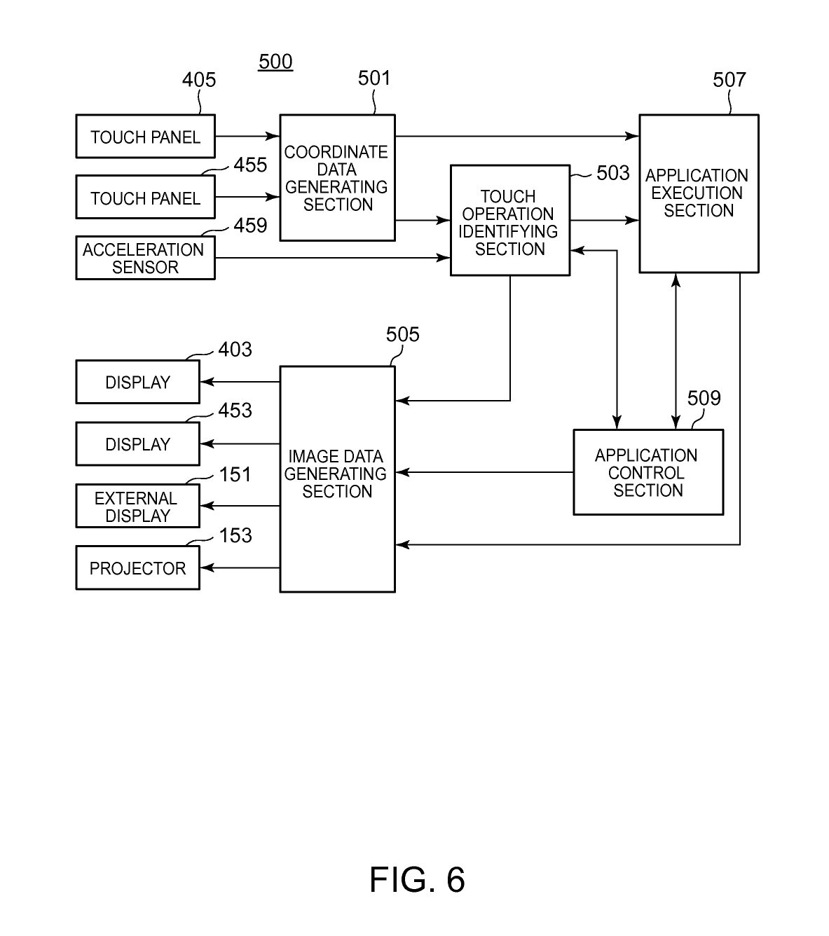

When the smartphone 100 is rotated 90 degrees to the right relative to the user from the state of FIG. 3A as shown in FIG. 3B, the relative position of the touch screen 200 and the touch screen 300 as seen from the user is that the touch screen 200 is the upside and the touch screen 300 is the downside. However, the right-and-left direction and the up-and-down direction relative to the user has significance for a display system 500 (FIG. 6) in a relationship with the relative position of the touch screens 200 and 300. The display system 500 equates the right-and-left direction in the state of FIG. 3A with the up-and-down direction in the state of FIG. 3B in the relationship with the relative position of the touch screens 200 and 300.

First, the state of FIG. 3A will be described. In association with the relative position of the touch screens 200 and 300, any of four directions, an up direction 211, a down direction 213, a left direction 215, or a right direction 217, is defined as the direction of the launch icon 203 as shown in FIG. 3C. Note that the number of directions to be defined for the launch icon in the present invention does not need to be limited to the four directions as long as it is two or more directions, i.e., it may be three directions or five or more directions.

FIG. 3D shows the relationship between the four directions defined for the launch icon 203 and the relative position of the touch screens 200 and 300. A center line 230 connecting the centers 200a and 300a of the touch screens 200 and 300, or a straight line parallel thereto, and each of arrows 231 to 237 originating from the center 203a of the launch icon 203 intersect at 45 degrees, respectively. The up direction 211, the down direction 213, the left direction 215, and the right direction 217 can be made to correspond to directions defined in a range of 90 degrees with respect to the arrows 237 to 231, the arrows 233 to 235, the arrows 231 to 233, and the arrows 235 to 237, respectively.

When the four directions are defined for the launch icon 203, at least four kinds of operations can be performed as the directions of gesture operations. For example, when a flick or swipe operation is used as a gesture operation, the movement of a finger in two different directions from the launch icon 203 as the start point enables an application image associated with the launch icon 203 to be displayed on either the touch screen 200 or the touch screen 300 intended by the user as the destination of the finger. Further, when a turning operation is used as the gesture operation, the left turning operation can be identified as a leftward gesture operation and the right turning operation can be identified as a rightward gesture operation.

At this time, although the up direction 211 may be made to correspond to the touch screen 200 and the down direction 231 may be made to correspond to the touch screen 300, if the direction of the gesture operation on the launch icon is made to match with the relative position of the touch screens 200 and 300, a touch screen can be selected intuitively. In other words, the left direction 215 of the launch icon 203 suggests the touch screen 200 and the right direction 217 suggests the touch screen 300. Therefore, when a flick operation in the left direction 215 is performed on the launch icon 203, the application image is displayed on the touch screen 200, while when a flick operation in the right direction 217 is performed, the application image is displayed on the touch screen 300. Thus, the position of the touch screen 200, 300 desired by the user to display and the direction of the flick operation can be made to match with each other.

At this time, since the corresponding touch screens 200 and 300 exist in the up direction 211 and the down direction 213, any other processes can be assigned to flick operations in the directions. For example, the assignment can be made to display an enlarged application image using the touch screens 200 and 300 as one screen in the case of the flick operation in the up direction 211 or to display a property window for an application with which the launch icon 203 is associated in the case of the flick operation in the down direction 213.

The property window shows a menu for configuring the settings specific to the application and indicating information on the application. For example, the property window shows a menu for configuring a setting for limiting the networks to access the application, limiting the notices of position information by a GPS, or limiting the accesses to the camera, a setting for the timing of data acquisition from a server, and a setting for limiting the system to make a transition to a sleep state during operation.

In the relationship between the direction of the gesture operation and the relative position of the touch screens 200 and 300, the left direction in FIG. 3A and the up direction in FIG. 3B have the same significance, so that the system determines and processes the direction of the gesture operation according to the attitude of the smartphone 100 relative to the user. The display system 500 uses the acceleration sensor to recognize the relationship between the center line 230 and the direction of gravitational force (the up-and-down direction for the user) so that a gesture operation for the launch icon 203 can be processed in the state of FIG. 3B in the same manner as in the state of FIG. 3A.

Specifically, in the state of FIG. 3B, an application image can be displayed on the touch screen 200 with a flick operation in the up direction 211 from the launch icon 203 as a start point, and the application image can be displayed on the touch screen 300 with a flick operation in the down direction 213. Further, an enlarged application image is displayed on the touch screens 200 and 300 as one screen with a flick operation in the right direction 217, and an application property window is displayed with a flick operation in the left direction 215.

Thus, the user can display the application image on the touch screen 200, 300 residing in a position that matches the direction of moving a finger by one flick operation on the launch icon. The flick operation is superior in terms of being able to complete the input operation in a short time, but the display of an application image or a property window may also be provided with a swipe operation, a drag operation, or a turning operation that suggests the display position of a touch screen from the direction of moving the finger like in the case of the flick operation.

Note that the display of an application image is not limited to being provided with a gesture operation, and a tap operation may be performed. Further, the gesture operation and the tap operation may be combined. For example, it is also possible in FIG. 3A to select either the touch screen 200 or the touch screen 300 on which an application image is to be displayed with a gesture operation on the launch icon 203 in the left direction 215 or the right direction 217, select both of the touch screens 200 and 300 with a single-tap operation, and display a property screen with a double-tap operation. Further, the launch icon group 351 moved to and residing on the virtual touch screen can be operated by a similar procedure after the page screen 150c is displayed on the touch screen 200 or the touch screen 300 with a swipe operation or a flick operation.

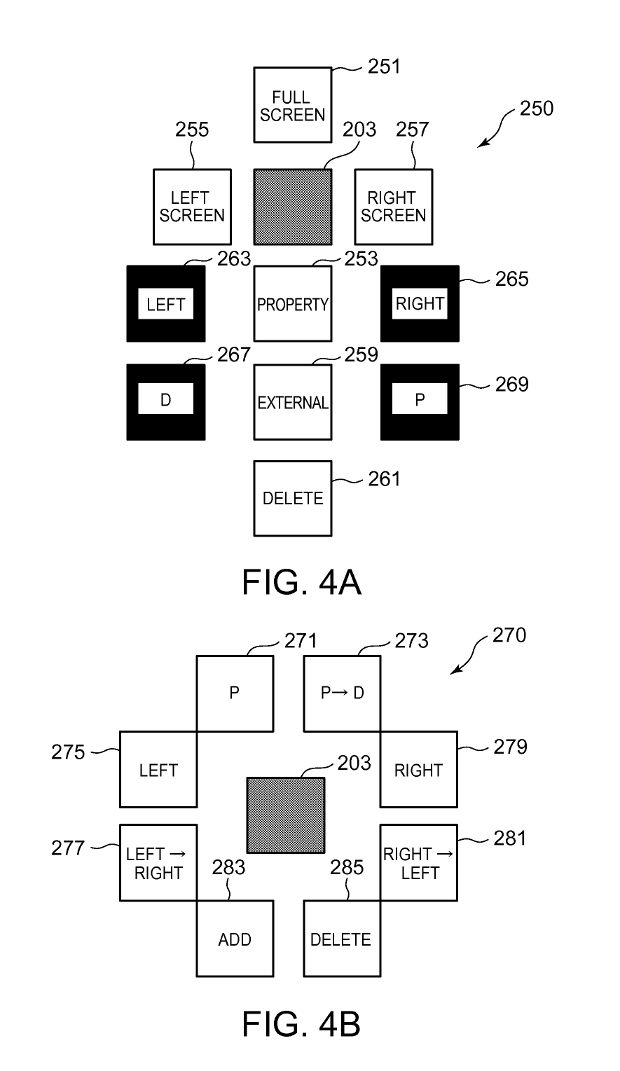

Next, another example of the application running method according to the embodiment will be described. FIG. 4 is a diagram for describing an example of an application running method using guide images 250 and 270. In the following, the description will be made by taking, as an example, a touch operation on the launch icon 203 shown in FIG. 3A. In the example of FIG. 4A, when a touch operation is performed on the launch icon 203, the display system 500 displays the guide image 250 made up of auxiliary images 251 to 261 around the launch icon 203. In this case, the touch operation corresponds to the start of a gesture operation subsequently performed. The auxiliary images 251 to 261 are displayed in an overlaid (superimposed) fashion or translucently, and disappear when a series of coherent touch operations is completed.

At the stage for displaying the auxiliary images 251 to 261, the display system 500 identifies a gesture operation subsequent to the touch operation to perform various corresponding processing without providing the display of an application image or a property window. The auxiliary images 251 to 261 include information for allowing the user to recognize operations for the launch icon 203 or information for assisting the recognition. Although an example of displaying the information with characters is shown in FIG. 4, the auxiliary images 251 to 261 can be configured as images, such as graphic figures, photos, symbols, or characters.

The auxiliary images 255 and 257 displayed on the left side and the right side of the launch icon 203 show information that implies the direction of the gesture operation with respect to the relative position of the touch screens 200 and 300 as seen from the launch icon 203. The auxiliary image 251 displayed above the launch icon 203 shows information that implies a display on both of the touch screens 200 and 300. The auxiliary image 253 displayed below the launch icon 203 shows information that implies the display of a property window.

The user performs a gesture operation such as a flick operation in the up direction 211, the down direction 213, the left direction 215, or the right direction 217 while viewing the auxiliary images 251 to 257 as needed to run an application associated with the launch icon 203 so that an application image can be displayed on the touch screen 200, 300 in a manner according to each operation, or a property window can be displayed.

The display system 500 can display the auxiliary images 259 and 261 below the launch icon 203 in a line in the down direction in addition to the auxiliary image 253. In this case, the display system 500 can effectively process only the drag operations to the auxiliary images 253, 259, and 261 as end points among gesture operations in the down direction 213 from the launch icon 203 as a start point. When the user performs a drag operation from the launch icon 203 to the auxiliary image 253, the system displays sub-auxiliary images 263 and 265 on both sides of the auxiliary image 253. The sub-auxiliary images 263 and 265 include information that implies the selection of the touch screen 200, 300 on which the property window is to be displayed.

When the user performs a gesture operation from the auxiliary image 253 toward the sub-auxiliary image 263, the display system 500 displays a property window for an application associated with the launch icon 203 on the touch screen 200, while when the user performs a gesture operation toward the sub-auxiliary image 265, the display system 500 displays the property window on the touch screen 300. Even in this case, if a flick operation is adopted, the operation can be completed in a short time.

When the user performs a drag operation from the launch icon 203 to the auxiliary image 259, the display system 500 displays sub-auxiliary images 267 and 269 on both sides of the auxiliary image 259. The sub-auxiliary images 267 and 269 include information that implies the selection of an external monitor on which an application image is to be displayed. Then, when the user performs a gesture operation from the auxiliary image 259 toward the sub-auxiliary image 267, the display system 500 runs an application associated with the launch icon 203, displays the application image on the external display 151, while when the user performs a gesture operation toward the sub-auxiliary image 269, the display system 500 displays the application image on the projector 153.

When the user performs a drag operation from the launch icon 203 to the auxiliary image 261, the application associated with the launch icon 203 is uninstalled. Note that there is no need to limit the number of auxiliary images and sub-auxiliary images displayed below the launch icon 203 to those illustrated here. Further, an auxiliary image from which sub-auxiliary images are displayed may also be displayed above the launch icon 203.

In the example of FIG. 4B, when the launch icon 203 is touched, the display system 500 displays the guide image 270 including eight auxiliary images 271 to 285 around the launch icon 203 as an example. The display system 500 can identify a gesture operation toward any of the auxiliary images 271 to 285 or a drag operation to any of the auxiliary images 271 to 285 as an end point, and perform processing corresponding to information implied by corresponding one of the auxiliary images 271 to 285. At this time, if a flick operation is adopted, input for the launch icon 203 can be completed in a short time.

The auxiliary image 271 includes information that implies that an application image associated with the launch icon 203 will be displayed instead of the application image displayed so far on the projector 153, and the auxiliary image 273 includes information that implies that the application image associated with the launch icon 203 will be displayed on the projector 153 after the application image displayed so far on the projector 153 is displayed on the external display 151. Note that the auxiliary image 271 or the auxiliary image 273 may also include information that implies that the same application image will be displayed on the external display 151 and the projector 153, respectively.

The auxiliary image 275 includes information that implies that the application image associated with the launch icon 203 will be displayed on the touch screen 200 instead of the application image displayed so far on the touch screen 200, and the auxiliary image 277 includes information that implies that the application image associated with the launch icon 203 will be displayed on the touch screen 200 after the application image displayed so far on the touch screen 200 is displayed on the touch screen 300.

The auxiliary image 279 includes information that implies that the application image associated with the launch icon 203 will be displayed instead of the application image displayed so far on the touch screen 300, and the auxiliary image 281 includes information that implies that the application image associated with the launch icon 203 will be displayed on the touch screen 300 after the application image displayed so far on the touch screen 300 is displayed on the touch screen 200.

The auxiliary images 283 and 285 can be displayed on the smartphone on which the home screen and the all application screen are displayed. When page screens 150a and 150b are all application screens, the auxiliary image 283 includes information that implies that the launch icon 203 will be added to the home screen, and the auxiliary image 283 includes information that implies that the application associated with the launch icon 203 will be uninstalled.

The use of the auxiliary images 250 and 270 allows the user to appreciate the direction of the gesture operation, and further to perform more operations on the launch icon including the display of sub-auxiliary images. When the smartphone is turned as shown in FIG. 3B, the display system 500 can detect a change in the attitude thereof using data of the acceleration sensor to turn the display direction of the guide images 250 and 270, and the directions of the auxiliary images.

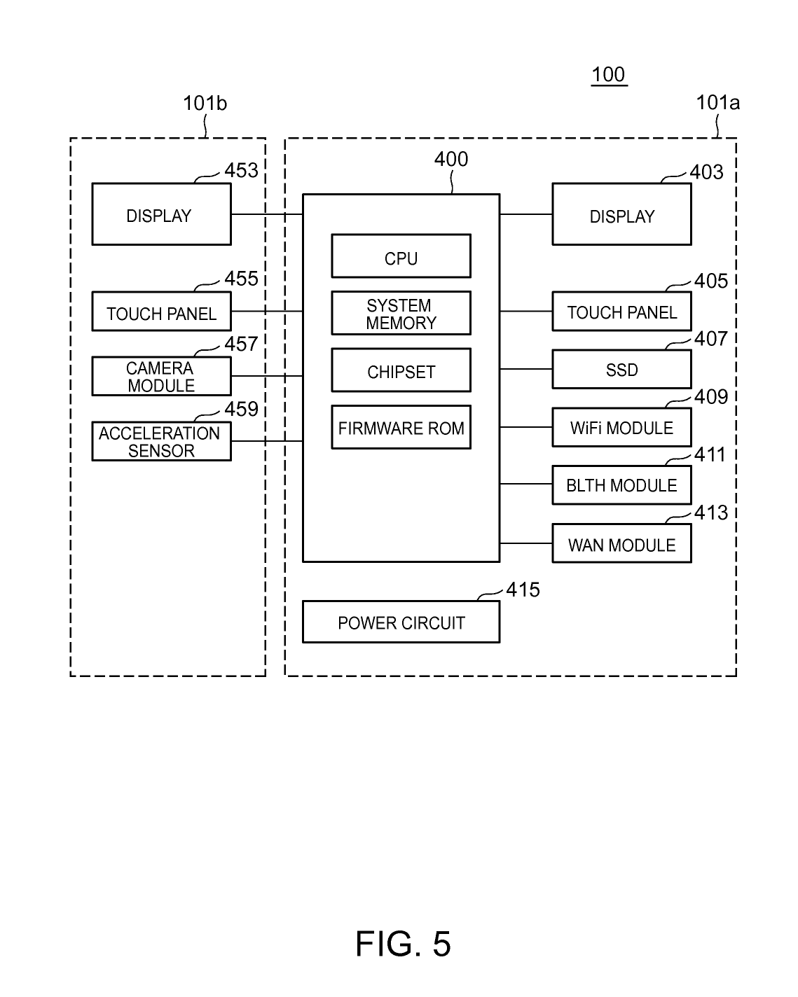

FIG. 5 is a functional block diagram showing an example of the hardware configuration of the smartphone 100. Since the hardware configuration of the smartphone 100 in the range of application of the present invention is known, the description thereof will be simplified. As an example, the chassis 101a is equipped with system hardware 400, a power circuit 415, a display 403 connected to the system hardware 400, a touch panel 405, an SSD 407, a WiFi (registered trademark) module 409, a Bluetooth (registered trademark) module (BLTH module 411), a WAN module 413, and the like.

The display 403 and the touch panel 405 constitute the touch screen 200. The chassis 101b is equipped with a display 453 connected to the system hardware 400, a touch panel 455, a camera module 457, an acceleration sensor 459, and the like. The display 453 and the touch panel 455 constitute the touch screen 300. The devices equipped in the chassis 101a and the devices equipped in the chassis 101b are wired through the hinge mechanisms 103a and 103b. Note that there is no need to limit the devices equipped between the chassis 101a and 101b in a shared manner to the example of FIG. 5. Although the smartphone 100 further includes more devices, the description thereof will be omitted because these are not required to understand the present invention.

The SSD 407 stores software such as an operating system (OS), applications, device drivers, and the like. The principal function of the display system 500 can be incorporated into the OS and the device drivers or either of the functions thereof. The OS can be iOS (registered trademark), Android (registered trademark), Windows phone (registered trademark), Windows RT (registered trademark), Windows 8 (registered trademark), or the like. The BLTH module 411 communicates with the external display 151 and the projector 153.

FIG. 6 is a functional block diagram for describing the configuration of the display system 500 for processing a touch operation on a launch icon. In addition to the hardware shown in FIG. 1 and FIG. 5, the display system 500 includes a coordinate data generating section 501, a touch operation identifying section 503, an image data generating section 505, an application execution section 507, and an application control section 509, which are configured in cooperation with the system hardware 400 and the software such as the OS and the device drivers.

The coordinate data generating section 501 generates input coordinates detected by the touch panels 405 and 455 when a touch operation is performed, and sends the input coordinates to the application execution section 507 and the touch operation identifying section 503. The touch operation identifying section 503 is aware of the coordinates of launch icons to be displayed on the page screens 151a to 153a, and identifies a launch icon on which the touch operation was carried out and the type of touch operation from the input coordinates detected by the touch panels 405 and 455.

The touch operation identifying section 503 is aware of the contents of processing corresponding to information implied by the auxiliary images of the guide images 250 and 270, and the directions of the auxiliary images from the launch icon. The touch operation identifying section 503 recognizes an inclination of the center line 230 shown in FIG. 3D based on data on the gravitational acceleration detected by the acceleration sensor 459. The touch operation identifying section 503 recognizes the direction of the touch screen from the center 300a toward the center 200a as the left direction 215, and the direction toward the opposite direction as the right direction 217.

The touch operation identifying section 503 sets the up direction 211 and the down direction 213 as directions vertical to the center line 230. Even if the attitude of the smartphone 100 is in the state of FIG. 3B, the touch operation identifying section 503 can convert and identify the direction of the gesture operation to that in the state of FIG. 3A based on data of the acceleration sensor 459. For example, since an upward gesture operation for the launch icon 203 in FIG. 3B as seen from the user corresponds to a direction from the center 300a toward 200a on the center line 230, the touch operation identifying section 503 recognizes that the gesture operation is the same operation as the gesture operation in the left direction 215 in FIG. 3A.

When recognizing a touch operation for starting a specific launch icon, the touch operation identifying section 503 sends a startup event to a corresponding application in the application execution section 507. The touch operation identifying section 503 sends the application control section a control event corresponding to the type of gesture operation performed on the launch icon. The control event includes information for performing processing implied by any of the auxiliary images shown in FIG. 4. When a gesture operation for the launch icon is performed, the touch operation identifying section 503 sends the image data generating section 505 image data for displaying the guide images 250 and 270 shown in FIG. 4 around the launch icon for which the touch operation was first detected.

The application execution section 507 runs each application based on the input coordinates received from the coordinate data generating section 501 or data from the other hardware. When receiving a startup event from the touch operation identifying section 503, the application execution section 507 generates image data for running a corresponding application and displaying an application image, and sends the image data to the image data generating section 505. When receiving a startup event corresponding to a gesture operation for displaying the touch screens 200 and 300 as one screen, the application execution section 507 can generate image data for displaying a corresponding application image.

The application control section 509 performs processing, such as the installation or uninstallation of an application, the display of a property window, and input processing to the property window. The application control section 509 selects the touch screen 200 or 300, on which an application image is to be displayed, according to the control event received from the touch operation identifying section 503, selects the external display 151 or the projector 153, and sends the image data generating section 505 a control event for displaying an application image.

The application control section 509 performs processing, such as the uninstallation of an application associated with the launch icon, the display of a property window, and the settings to the property window, according to the control event received from the touch operation identifying section 503. The application control section 509 sends image data for displaying, on a predetermined one of the page screens 150a to 150c, a launch icon generated when an application is installed in the image data generating section 505, and notifies the touch operation identifying section 503 of the coordinates.

The image data generating section 505 converts, to a display format, image data received from the application execution section 507, the touch operation identifying section 503, or the application control section 509, and outputs the image data to the display 403, 453, the external display 151, or the projector 153. At this time, the image data generating section 505 selects an output destination based on the control event received from the application control section 509.

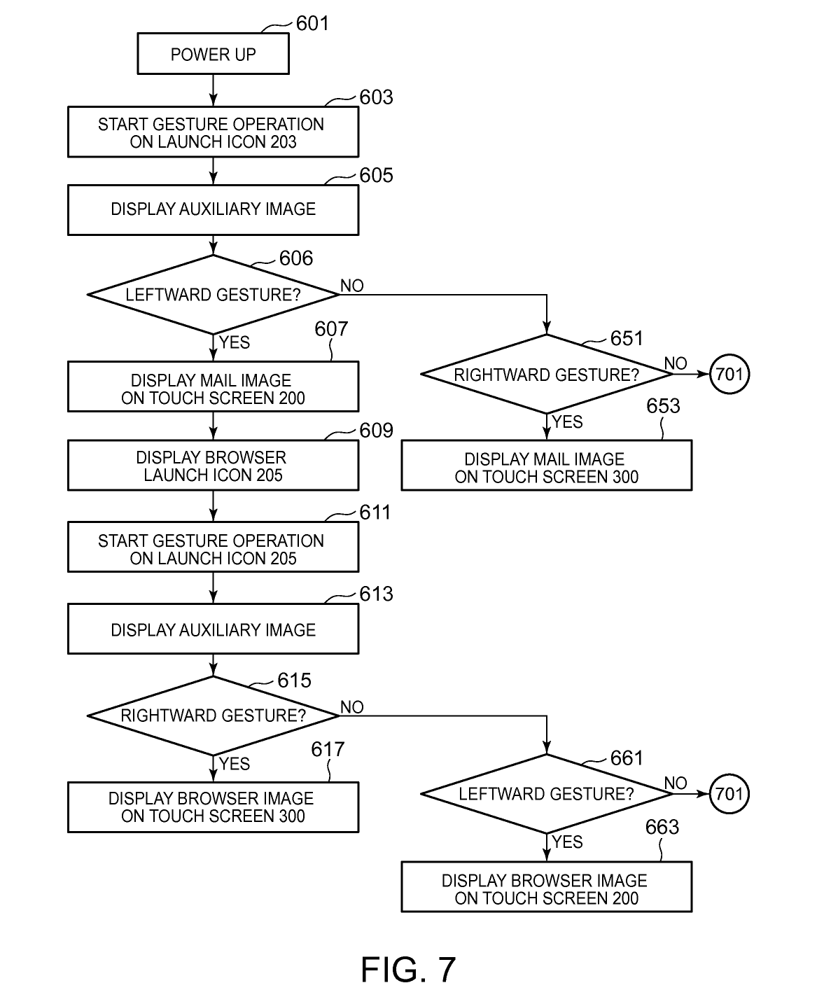

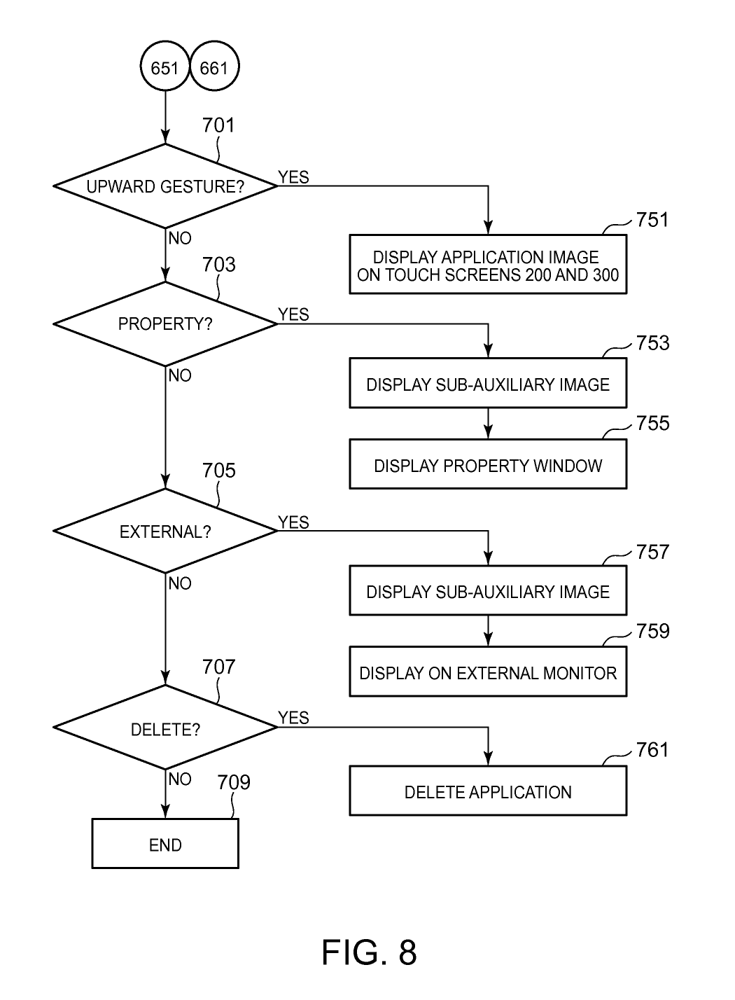

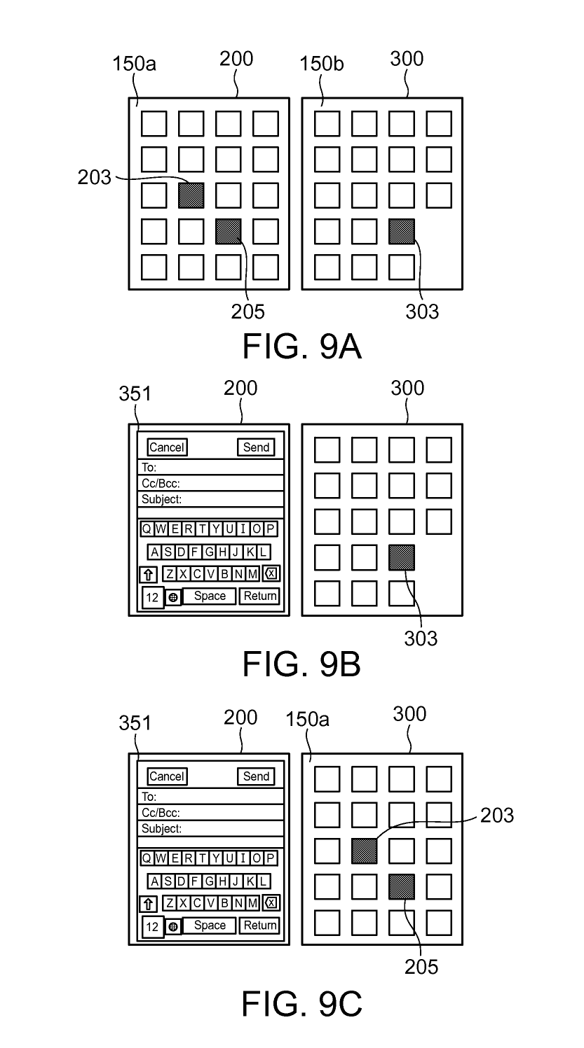

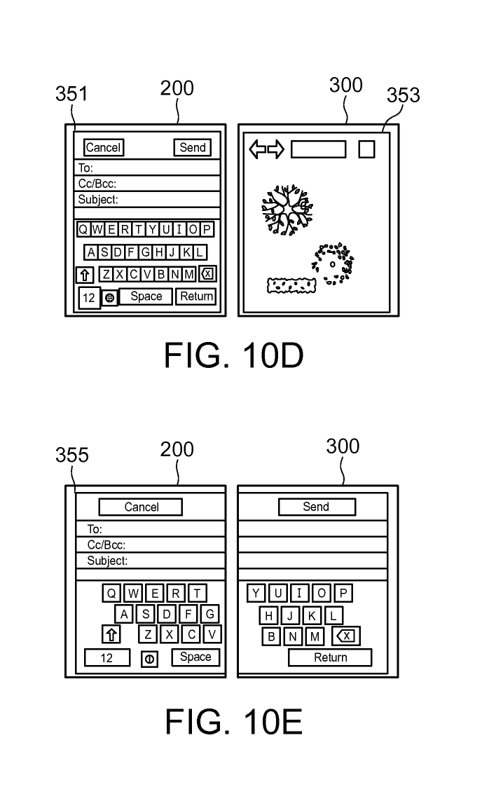

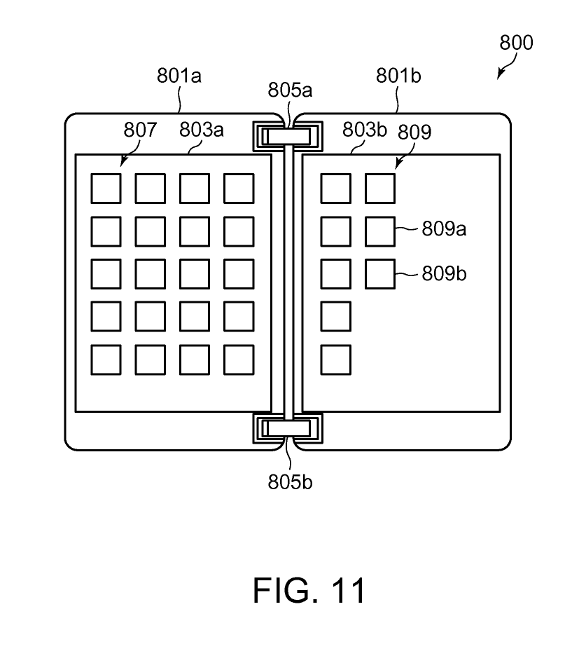

FIG. 7 and FIG. 8 are flowcharts for describing an example of the operation of the display system 500. FIG. 9 and FIG. 10 are diagrams showing a screen state of the touch screens 200 and 300 that vary according to the procedure in FIG. 7 or FIG. 8. Here, the description will be made by exemplifying a case where the auxiliary images shown in FIG. 4A are displayed in the state of FIG. 3A, but the operation in the case where the auxiliary images shown in FIG. 4B are displayed in the state of FIG. 3B, and the operation in the case where no auxiliary image is displayed can also be understood from this description. When power is up in block 601, the display system 500 displays page screens 150a and 150b on the touch screens 200 and 300 as shown in FIG. 9A.

The page screens 150a and 150b shows multiple launch icons including launch icons 203, 205, and 303. It is assumed that a mailer is associated with the launch icon 203, and a web browser is associated with the launch icon 205. Here, it is assumed that the user wants first to run the mailer and display a mailer image on the touch screen 200. In block 603, the user performs a gesture operation from the launch icon 203 as a start point. Although the user ends up performing a gesture operation in the left direction, the display system recognizes and processes gesture operations in all the directions.

The display system 500 that has detected input to the coordinates of the launch icon 203 displays the auxiliary images 251 to 261 shown in FIG. 4A around the launch icon 203 in block 605. The display system 500 identifies the direction of a series of gesture operations starting from block 603. When the display system 500 recognizes a gesture operation in the left direction 215 in block 606, the procedure proceeds to block 607, while when it recognizes any gesture operation other than the gesture operation in the left direction 215, the procedure proceeds to block 651.

In block 607, the display system 500 runs a mailer application associated with the launch icon 203, and displays a mailer image 351 on the touch screen 200 as shown in FIG. 9B. Here, it is assumed that the user wants to open the web browser in order to acquire information from a network while entering mail sentences. Since the mailer image 351 is displayed on the touch screen 200, a gesture operation cannot be performed on the launch icon 205.

Previously, since there was a need to operate the home button 111 or perform a predetermined touch operation on the touch screen 200, 300 in order to display a browser image 353 (FIG. 10D) on the touch screen 200 after transition to the page screen 150a on which the launch icon 205 is to be displayed, the touch screen 300 that is not in use could not be used effectively due to the interruption of the display of the mailer image 351 or due to spending time in switching operations.

In the embodiment, a flick operation or a swipe operation in the right direction is performed on the touch screen 300 in block 609 to display the page screen 150a including the launch icon 205 on the touch screen 300. This state is shown in FIG. 9C. In block 611, the user starts a gesture operation from the launch icon 205 as a start point on the touch screen 300. The display system 500 that has detected input to the coordinates of the launch icon 205 displays the auxiliary images 251 to 261 in block 613.

The display system 500 recognizes the direction of a series of gesture operations starting from block 611. When the display system 500 recognizes a gesture operation in the right direction 217 in block 615, the procedure proceeds to block 617, while when it recognizes any gesture operation other than the gesture operation in the right direction 217, the procedure proceeds to block 661. In block 617, the display system 500 runs the web browser associated with the launch icon 205, and displays a browser image 353 on the touch screen 300 as shown in FIG. 10D.

When the display system 500 recognizes a gesture operation in the right direction in block 651, the mailer image 351 is displayed on the touch screen 300 in block 653, while when it recognizes any gesture operation other than the gesture operation in the right direction, the procedure proceeds to block 701 in FIG. 8. When the display system 500 recognizes a gesture operation in the left direction in block 661, the browser image 353 is displayed on the touch screen 200 in block 663, while when it recognizes any gesture operation other than the gesture operation in the left direction, the procedure proceeds to block 701 in FIG. 8.

At this time, the mailer image 351 displayed on the touch screen 200 in block 607 is overlaid. Here, in a case where the display system 500 displays the auxiliary images 271 to 275 shown in FIG. 4B in block 613, when recognizing a gesture operation toward the auxiliary image 277, the display system 500 can display, on the touch screen 300, the mailer image 351 displayed on the touch screen 200, and display the browser image 353 on the touch screen 200.

When only the drag operation is enabled among downward gesture operations, the display system 500 identifies in block 701 of FIG. 8 whether the gesture operation performed in block 606 or block 615 is a downward drag operation or an upward gesture operation. In block 701, when the display system 500 recognizes the upward gesture operation, the procedure proceeds to block 751, or otherwise, i.e., when it recognizes the downward drag operation, the procedure proceeds to block 703. In block 751, the display system 500 uses the touch screens 200 and 300 as one screen to display the mailer image 351 upon transition from block 651, or display the browser image 353 upon transition from block 661. The state of displaying the mailer image 355 at this time is shown in FIG. 10E.

In block 703, the display system 500 recognizes the coordinates of the end point of the drag operation. In block 703, when it recognizes the auxiliary image 253, the procedure proceeds to block 753 to display sub-auxiliary images 263 and 265. In block 755, the display system 500 recognizes the direction of a gesture operation from the auxiliary image 253 as a start point, and displays a property window for the mailer or the web browser on either the touch screen 200 or the touch screen 300.

In block 705, when the display system 500 recognizes the auxiliary image 259 as the end point of the drag operation, the procedure proceeds to block 757 to display the sub-auxiliary images 267 and 269. In block 757, the display system 500 recognizes the auxiliary image 259 as the start point and the direction of a gesture operation, and displays the mailer image 351 or the browser image 353 on the external display 151 or the projector 153. In block 707, when the display system 500 recognizes the auxiliary image 261 as the start point of the drag operation, the procedure proceeds to block 761 to delete the mailer or the web browser.

While the present invention has been described with reference to the specific embodiment shown in the drawings, the present invention is not limited to the embodiment shown in the drawings. It is needless to say that any known configuration can be employed as long as the configuration has the effects of the present invention.

What is claimed is:

1. A program product comprising a computer readable storage medium that stores code executable by a processor, the executable code comprising code to perform:
displaying a launch icon on a first display;
identifying a type of touch operation conducted by a user on the launch icon; and
displaying an application image associated with the launch icon on the first display or on a second display according to the identified type of touch operation conducted on the launch icon.

2. The program product of claim 1, wherein the touch operation is a gesture operation originating at the launch icon as a starting point.

3. The program product of claim 2, wherein the gesture operation is a flick operation.

4. The program product of claim 2, further comprising code to perform:
displaying the application image on the first display when a gesture operation in a direction of the first display relative to the second display is detected; and
displaying the application image on the second display when a gesture operation in a direction of the second display relative to the first display is detected.

5. The program product of claim 2, further comprising code that, when a gesture operation in a predetermined direction is detected, causes an application image to be displayed on the first display after the application image already displayed on the first display is displayed on the second display.

6. The program product of claim 2, further comprising code that, when a gesture operation in a predetermined direction is detected, an application image that uses the first display and the second display as one screen is displayed on the first display and the second display.

7. The program product of claim 2, further comprising code that, when a gesture operation in a predetermined direction is detected, a property window for an application program associated with the launch icon is displayed.

8. The program product of claim 2, further comprising code that, when a gesture operation in a predetermined direction is detected, the application image is displayed on an external monitor connected to the electronic device.

9. The program product of claim 1, further comprising code that, when a gesture operation in a predetermined direction is detected, an application program associated with the launch icon is deleted. The program product of claim 1, wherein the second display is a touch-operable display, and further comprising code that:
displays an application image on the first display in a manner to be overlaid on the launch icon before a touch operation on the launch icon is detected;
displays the launch icon on the second display in response to a gesture operation on the second display; and
displays an application image associated with the launch icon on the second display according to a type of touch operation on the launch icon displayed on the second display.

10. A method comprising:
displaying a launch icon on a first display;
identifying a type of touch operation conducted by a user on the launch icon; and
displaying an application image associated with the launch icon on the first display or on a second display, according to the identified type of touch operation.

11. The method of claim 11, wherein displaying the application image includes:
displaying the application image on the first display when a gesture operation headed for the first display from the second display is identified; and
displaying the application image on the second display when a gesture operation headed for the second display from the first display is identified.

12. The method of claim 12, wherein displaying the application image includes
displaying the application image on the first display and the second display, respectively, when a gesture operation headed in a predetermined direction is identified.

13. An apparatus comprising:
a first display that enables a touch operation on a launch icon;
a second display; and
a memory that stores code executable by the processor, the code comprising:
code that displays a launch icon on the first display;
code that identifies a type of touch operation conducted by a user on the launch icon; and
code that displays an application image associated with the launch icon on the first display or on the second display according to the identified type of touch operation conducted on the launch icon.

14. The apparatus of claim 14, wherein the touch operation is a gesture operation originating at the launch icon as a starting point.

15. The apparatus of claim 15, wherein the gesture operation is a flick operation.

16. The apparatus of claim 14 wherein the first display and second display are retained within a foldable electronic device configured such that two chassis equipped respectively with the first display and the second display are coupled by a hinge mechanism.

17. The apparatus of claim 17, further comprising an control module that displays the application image on the first display when a gesture operation headed in the direction of the first display from the second display is identified, and displays the application image on the second display when a gesture operation headed in the direction of the second display from the first display is identified.

18. The apparatus of claim 14, further comprising:
a touch operation identifying module for identifying a type of touch operation on the launch icon; and
an application control module for displaying an application image associated with the launch icon on the display and the external monitor, or on either one thereof according to the identified type of touch operation identified by the touch operation identifying module.

19. The apparatus of claim 19, wherein the application control module displays the application image on the display when a first gesture operation headed in a first direction is identified, and displays the application image on the external monitor when a second gesture operation headed in a second direction is identified.
